(19) United States
(12) Patent Application Publication
(10) Pub. No.: US 2006/0075570 A1
(43) Pub. Date: Apr. 13, 2006

(54) Multi-functional knife having a mirror, flashlight and storage compartment

(76) Inventor: Jonathan D. Gelfand, Los Angeles, CA (US)

Correspondence Address: SNELL & WILMER LLP, 600 ANTON BOULEVARD, SUITE 1400, COSTA MESA, CA, 92626, US

(21) Appl. No.: 10/965,467

(22) Filed: Oct. 13, 2004

(51) Int. Cl. B26B 11/00; B25F 1/00

(52) U.S. Cl. 7/118; 7/151; 7/158; 7/160; 7/162; 7/163

(57) ABSTRACT

A hand held multi-functional knife may include a body defining a cavity and a groove and a blade configured to move into and out of the groove of the body. The hand held knife may also include a cover having an inner surface and being rotatably attached to the body to move between an open position and a closed position, and a mirror attached to the inner surface of the cover, the mirror being visible when the cover is in the open position and being concealed when the cover is in the closed position. The mirror may also be fixedly attached or removably attached to the body. The hand held multi-functional knife may further include a light emitting diode positioned within the body.

### FIELD OF THE INVENTION

The invention relates generally to a multi-functional knife, and more particularly to a multi-functional knife having a mirror, flashlight and storage compartment.

### DESCRIPTION OF RELATED ART

Conventional folding knives can be used for various cutting needs, for example, during camping and hiking trips. These conventional folding knives typically include a handle and a blade, which is pivotably attached to the handle, having a sharp edge for the user's various cutting needs. The blade can pivot between an open position and a closed position. In the open position, the sharp edge is exposed to provide cutting and piercing actions. In the closed position, the sharp edge is concealed to prevent the inadvertent cutting or piercing of objects. With folding knives, the length of the blade is generally shorter than the length of the handle to allow the blade to be completely concealed within the handle. The handle may provide a gripping surface for better alignment of the blade with respect to the material or object being cut. One example of a conventional folding knife is a Swiss Army knife, manufactured by Victorinox.

### SUMMARY OF THE INVENTION

In particular, and by way of example only, one embodiment of the invention includes a hand held device including a body having a groove, a tool pivotably attached to the body and configured to move into and out of the groove, and a mirror moveably coupled to the body. The body may have a compartment positioned under the mirror when the mirror is in a closed position.

One embodiment of the invention includes a hand held multi-functional knife including a body defining a cavity and a groove, a blade configured to move into and out of the groove of the body, a cover having an inner surface and being rotatably attached to the body to move between an open position and a closed position, and a mirror attached to the inner surface of the cover, the mirror being visible when the cover is in the open position and being concealed when the cover is in the closed position.

One embodiment of the invention includes a hand held device including a handle, a tool coupled to the handle, and a mirror moveably coupled to the handle.

These and other features and advantages of the embodiments of the invention will become apparent from the following detailed description, taken in conjunction with the accompanying drawings, which illustrate, by way of example, the principles of the invention.

### BRIEF DESCRIPTION OF THE DRAWINGS

FIG. 1 is a front view of a multi-functional knife having one or more folding or retractable tools and a cover shown in an opened position according to an embodiment of the invention;

FIG. 2 is a rear view of the multi-functional knife of FIG. 1 where the tools are shown in a retracted position and the cover is shown in a closed position according to an embodiment of the invention;

FIG. 3 is a right side view of the multi-functional knife of FIG. 1 where the tools are shown in a retracted position and the cover is shown in a closed position according to an embodiment of the invention;

FIG. 4 is a left side view of the multi-functional knife of FIG. 1 where the tools are shown in a retracted position and the cover is shown in a closed position according to an embodiment of the invention; and

FIG. 5 is a top view of the multi-functional knife of FIG. 1 where the tools are shown in a retracted position and the cover is shown in a closed position according to an embodiment of the invention.

### DETAILED DESCRIPTION OF THE PREFERRED EMBODIMENTS

Systems and methods that implement the embodiments of the various features of the invention will now be described with reference to the drawings. The drawings and the associated descriptions are provided to illustrate embodiments of the invention and not to limit the scope of the invention. Reference in the specification to “one embodiment” or “an embodiment” is intended to indicate that a particular feature, structure, or characteristic described in connection with the embodiment is included in at least an embodiment of the invention. The appearances of the phrase “in one embodiment” in various places in the specification are not necessarily all referring to the same embodiment. Throughout the drawings, reference numbers are re-used to indicate correspondence between referenced elements. In addition, the first digit of each reference number indicates the figure in which the element first appears.

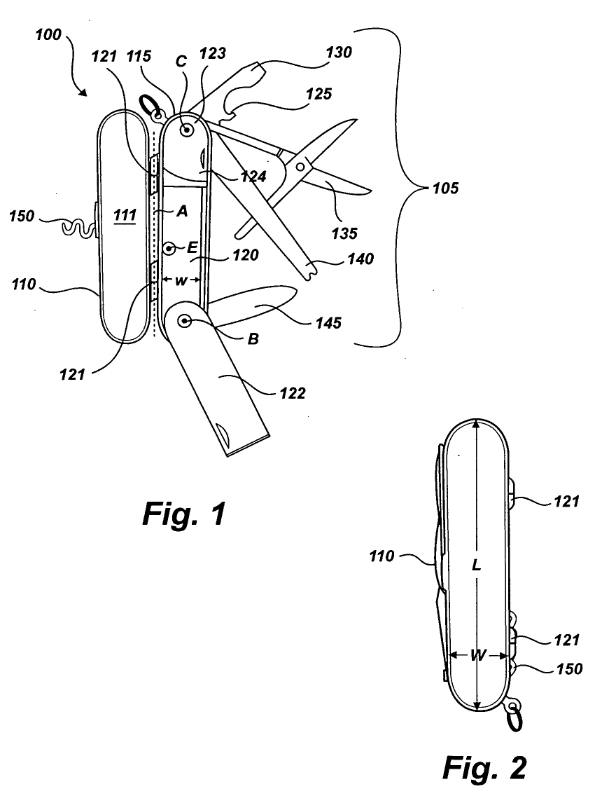

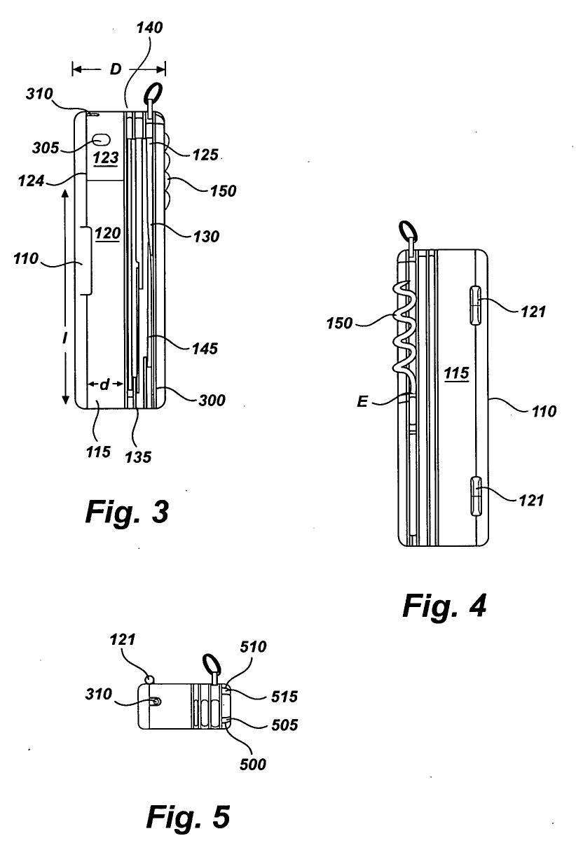

Referring now more particularly to the drawings, FIG. 1 is a front view of a multi-functional knife 100 having one or more folding or retractable tools 105 and a cover 110 shown in an open position. In addition, the knife 100 has a housing 115 defining a cavity or a compartment 120 that can be opened and closed using the cover 110. The housing 115 may be made of a plastic, stainless steel, fiberglass, gold, silver, metallic, titanium, enamel or wooden material. In one embodiment, the housing 115 has a length L of about 9.0 centimeters (cm), a width W of about 2.0 cm, and a depth D of about 2.75 cm (see also FIGS. 2 and 3). The one or more tools 105 can be one or more of the following: a bottle opener 125 with a screwdriver tip 130, a scissors 135, a nail file 140, a blade 145, a cork screw 150, and other devices such as a brush, a comb, a pick, a ruler, a tweezers and a tooth brush. Each tool 105 is generally pivotably coupled to the housing 115. As shown in FIG. 1, for example, the bottle opener 125, the scissors 135, and the nail file 140 are pivotably coupled to a top end of the housing 115 and rotate about an axis C. The blade 145 is pivotably coupled to a bottom end of the housing 115 and rotates about an axis B. The cork screw 150 is pivotably coupled to a middle section of the housing 115 and rotates about an axis E. The tools 105 can pivot between an open position and a closed position. In the open position, the tools 105 can be used by the user. In the closed position, the tools 105 are retracted, which prevent the tools 105 from being used, and provide for a compact device (e.g., knife 100).

The knife 100 may have a mirror 111 that may be coupled to an inner surface of the cover 110. The mirror 111 is visible when the cover 110 is in an open position (as shown in FIG. 1) and is concealed when the cover 110 is in a closed position. The mirror 111 may also be used in place of the cover 110 to cover and uncover the compartment 120. In this embodiment, the mirror 111 may be a single or double-sided mirror that is movably coupled to the housing 115. In one embodiment, the mirror 111 may be slidable into a slot located within the housing 115. The slot allows the user to slide the mirror 111 into and out of the housing 115. Hence, the mirror 111 may be removable or detachable from the housing 115. In one embodiment, the mirror 111 may be attached or coupled to the rear surface of the knife 100 as shown in FIG. 2. In this embodiment, the mirror 111 can be fixedly attached or removably attached to the rear surface of the knife 100. The mirror 111 can be removably attached to the rear surface using Velcro or any other type of removable material.

The cover 110 can pivot or rotate between an open position and a closed position using one or more hinges 121. When two hinges 121 are used, a user can cause the cover 110 to pivot or rotate about an axis A that is substantially parallel to a side of the housing 115. In one embodiment, a separate compartment cover 122 can be used to cover and uncover the compartment 120. In this embodiment, the cover 110 fits over the compartment cover 122. The compartment cover 122 can pivot or rotate about an axis B that is substantially perpendicular to the axis A.

The knife 100 may also include a battery compartment 123 that can be opened and closed using a battery cover 124. The battery cover 124 can pivot or rotate about an axis C that is substantially perpendicular to the axis A. The battery compartment 123 can house a battery that is used to power a light emitting diode 310. The knife 100 may include a button 305 on the housing 115 that is used to turn on the light emitting diode 310 for providing light to the surroundings.

The compartment 120 can be used to store bobby pins, clothes pins, perfume viles, bubble gum, aspirin tablets and capsules, floss, tooth brushes, tooth paste, jewelry, needles, thread, and other components that can be used by the user of the knife 100. In one embodiment, the compartment 120 has a length 1 of about 6.0 cm, a width w of about 1.8 cm, and a depth d of about 0.75 cm (see FIGS. 1 and 3). As shown in FIG. 3, when in the closed or retracted position, the tools 105 can fit into one or more grooves 300.

Referring to FIG. 5, the knife 100 may also include a first channel 500 positioned within the housing 115 for holding a pen 505 and a second channel 510 positioned within the housing 115 for holding a tweezers 515. The pen 505 and the tweezers 515 are slidably removable from the housing 115 for use by the user. Other devices can also be positioned within the housing 115 and slidably removable from the housing 115 for use by the user.

Although an exemplary embodiment of the invention has been shown and described, many other changes, combinations, omissions, modifications and substitutions, in addition to those set forth in the above paragraphs, may be made by one having skill in the art without necessarily departing from the spirit and scope of this invention. Accordingly, the innovation is not intended to be limited by the preferred embodiments, but is to be defined by reference to the appended claims.

What is claimed is:

1. A hand held device comprising:
a body having a groove;
a tool pivotably attached to the body and configured to move into and out of the groove; and
a mirror coupled to the body.

2. The hand held device of claim 1 wherein the body defines a cavity having an opening facing the mirror when the mirror is in a closed position.

3. The hand held device of claim 2 further comprising a cover pivotably attached to the body to cover and uncover the cavity.

4. The hand held device of claim 1 wherein the body has a cavity positioned under the mirror when the mirror is in a closed position.

5. The hand held device of claim 4 further comprising a cover pivotably attached to the body to cover and uncover the cavity.

6. The hand held device of claim 1 wherein the tool is selected from a group consisting of a blade, a bottle opener, a brush, a comb, a cork screw, a nail file, a pick, a ruler, a scissors, a screwdriver tip, a tweezers and a tooth brush.

7. The hand held device of claim 1 wherein the mirror is moveably coupled to the body using a hinge.

8. The hand held device of claim 1 further comprising a member attached to the mirror, the member selected from a group consisting of a cover, a door, a flap and a sheet.

9. The hand held device of claim 1 further comprising a light emitting diode positioned within the body.

10. The hand held device of claim 1 further comprising a channel positioned within the body for holding a hair pick, a pen, a toothpick, or a tweezers.

11. The hand held device of claim 1 wherein the mirror is moveably coupled to the body.

12. The hand held device of claim 1 wherein the mirror is detachably coupled to the body.

13. A hand held device comprising:
a body having a groove and a storage compartment;
a tool pivotably attached to the body and configured to move into and out of the groove; and
a cover rotatably attached to the body to cover and uncover the storage compartment.

14. The hand held device of claim 13 further comprising a mirror coupled to the body or the cover.

15. The hand held device of claim 13 wherein the tool is selected from a group consisting of a blade, a bottle opener, a brush, a comb, a cork screw, a nail file, a pick, a ruler, a scissors, a screwdriver tip, a tweezers and a tooth brush.

16. The hand held device of claim 13 further comprising a light emitting diode positioned within the body.

17. The hand held device of claim 13 further comprising a channel positioned within the body for holding a hair pick, a pen, a toothpick, or a tweezers.

18. A hand held multi-functional knife comprising:
a body defining a cavity and a groove;
a blade configured to move into and out of the groove of the body;
a cover having an inner surface and being rotatably attached to the body to move between an open position and a closed position; and
a mirror attached to the inner surface of the cover, the mirror being visible when the cover is in the open position and being concealed when the cover is in the closed position.

19. The hand held multi-functional knife of claim 18 further comprising a tool selected from a group consisting of a blade, a bottle opener, a brush, a comb, a cork screw, a nail file, a pick, a ruler, a scissors, a screwdriver tip, a tweezers and a tooth brush.

20. The hand held multi-functional knife of claim 18 further comprising a light emitting diode positioned within the body.

21. The hand held multi-functional knife of claim 18 further comprising a channel positioned within the body for holding a hair pick, a pen, a toothpick, or a tweezers.

22. The hand held multi-functional knife of claim 18 wherein the body is made of a material selected from a group consisting of plastic, stainless steel, fiberglass, gold, silver, metallic, titanium, enamel or wood.

23. A hand held device comprising:
a handle;
a tool coupled to the handle; and
a mirror coupled to the handle.

24. The hand held device of claim 23 wherein the handle defines a cavity having an opening facing the mirror when the mirror is in a closed position.

25. The hand held device of claim 24 further comprising a cover pivotably attached to the handle to cover and uncover the cavity.

26. The hand held device of claim 23 wherein the handle has a cavity for the storage of one or more items.

27. The hand held device of claim 26 further comprising a cover pivotably attached to the handle to cover and uncover the cavity.

28. The hand held device of claim 23 wherein the tool is selected from a group consisting of a blade, a bottle opener, a brush, a comb, a cork screw, a nail file, a pick, a ruler, a scissors, a screwdriver tip, a tweezers and a tooth brush.

29. The hand held device of claim 23 wherein the mirror is moveably coupled to the handle using a hinge.

30. The hand held device of claim 23 further comprising a member attached to the mirror, the member selected from a group consisting of a cover, a door, a flap and a sheet.

31. The hand held device of claim 23 further comprising a light emitting diode positioned within the handle.

32. The hand held device of claim 23 further comprising a channel positioned within the handle for holding a hair pick, a pen, a toothpick, or a tweezers.

33. The hand held device of claim 23 wherein the mirror is moveably coupled to the handle.

34. The hand held device of claim 23 wherein the mirror is detachably coupled to the handle.
